(19) United States
(12) Patent Application Publication
(10) Pub. No.: US 2008/0121580 A1
(43) Pub. Date: May 29, 2008

(54) Geometrically Variable Filter Underdrain Header

(75) Inventors: Michael R. Ekholm, Minneapolis, MN (US); Mark E. Watson, Sturbridge, MA (US); Thomas J. Steinke, Columbia Heights, MN (US)

Correspondence Address: WONG, CABELLO, LUTSCH, RUTHERFORD & BRUCCULERI,;L.L.P., 20333 SH 249, SUITE 600, HOUSTON, TX, 77070, US

(73) Assignee: WEATHERFORD/ LAMB, INC., Houston, TX (US)

(21) Appl. No.: 11/563,309

(22) Filed: Nov. 27, 2006

(51) Int. Cl. B01D 24/00

(52) U.S. Cl. 210/274; 210/293

(57) ABSTRACT

An embedded geometrically variable filter underdrain header and a method for constructing such a filter. Often the variation is a decrease in cross section along the header from the backwash media source, which avoids a pressure loss as liquid is diverted to the laterals along the header. The header is formed inside a filter underdrain basin and is embedded in the basin. The method for constructing the basin and header includes providing a mold for the basin and the header and filling the molds with concrete by pouring concrete into the area between the interior of the mold for the basin and the exterior of the mold for the header. After the concrete cures, the mold for the basin may or may not be removed, while the mold for the header is kept in place.

### FIELD OF THE INVENTION

The invention relates to filtration systems. In particular, the invention relates to filter underdrain design and construction.

### BACKGROUND OF THE INVENTION

Filtration systems are prevalent tools for filtering water and other liquids. Such systems typically include a basin containing a bed of particulate matter, also known as filtration media, through which travels the liquid to be filtered. The filtration media typically comprise one or more layers of sand, gravel, etc., of various types and sizes, which are well-known in the art. The filtration media are supported by an underdrain.

The underdrain surface supporting the filter media typically includes orifices in fluid communication with minor passages leading to a lower chamber. These orifices are smaller than the size of the adjacent filtration media particles, so that the liquid can pass through the orifices, but the filter media cannot. The underdrain surface may also be implemented as a screen.

FIG. 1C illustrates a plan view of a prior art filter 100. The filter 100 includes laterals 110, lain in a basin 108. FIG. 1A illustrates a view of filter 100 across one lateral at cross section A of FIG. 1C. FIG. 1B illustrates a view of filter 100 across all the laterals 110 at cross section B of FIG. 1C. Each lateral's 110 top surfaces are joined together side-by-side between the basin walls 116 so that the combined top surfaces of the laterals form the top surface of the underdrain (104, FIGS. 1A-1B).

Each lateral 101 is connected to a header 106 along the length of the header 106 by a major passage 112. Each lateral 110 has a screen through which the filtered liquid may travel to reach the header 106 via its major passage 112. Historically, each header's 106 cross-sectional area has been the same along the length of header 106.

In operation, unfiltered liquid is passed through the filtration media. The liquid travels through the spaces between filtration media particles, while impurities (i.e., suspended solids) in the liquid are trapped and thereby filtered out of the liquid. The filtered liquid may then be directed elsewhere for use or further treatment. Eventually, the filtration media becomes blocked by the trapped impurities. Thus, filtration systems are typically cleaned by forcing liquid and/or air or another gas backwards through the filtration media, in a process known as backwashing. Backwashing is carried out by receiving water from a backwashing source 114 in the header 106 and distributing the water through the header 106 to each lateral 110. The backwash flows through the passages 112 to each lateral 110, out of the orifices (not shown) in each lateral, and backwards through the filtration media 102.

It is highly desirable that backwash flow be uniformly distributed throughout the filter bed. A non-uniform backwash flow is problematic because too little flow provides little cleaning effect, while too much flow causes filter media to be carried upward and lost to disposal. Non-uniform backwashing may also cause mixing of the filtration media's layers and other undesirable effects.

Non-uniform backwashing may be caused by unequal flow to each lateral 110. This unequal flow may be caused by pressure drops along the length of the header 106. The pressure drop is caused by the flow diverted to each lateral 110, and may be exacerbated by hydraulic losses in the header 106. Some prior art systems have addressed this problem by varying the size or shape of the passages through which the liquid travels from the header 106 to the lateral 110, thus controlling the differential pressure between the laterals. Other prior art systems have addressed this problem by reducing the pressure drop along the header 106 by geometrically varying the header cross section. Typically, this geometric variation has taken the form of decreasing the cross section, or tapering the header 106.

Non-uniform backwashing may also be caused by a “shadowing” effect created by the fluid flowing around the header above the filtration media. An embedded header eliminates this shadowing by placing the header out of the fluid flow path. Prior art embedded headers have included standard pipes embedded in the basin wall or floor.

Both embedding the header in the basin wall and using geometrically variable headers reduce non-uniformity in backwashing flow. An ideal design, therefore, would include a geometrically variable underdrain header embedded in the basin. However, limitations in available construction materials and methods have prevented the construction of such filters. Disclosed herein are designs and construction techniques that address the deficiencies of the prior art.

### SUMMARY OF THE INVENTION

Disclosed herein are designs and construction techniques for embedded geometrically variable filter underdrain headers. The header's geometric variation is typically a decrease in cross section along the header. The header is formed inside a filter underdrain basin and is encapsulated by the basin wall or floor.

Constructing the filter includes providing a basin form and a header mold. Constructing the filter further includes filling the basin form with concrete by pouring concrete. After the concrete cures, the header mold is kept in place. Although the header mold defines the header, it does not constitute the header. The basin wall or floor in which the header is embedded provides the structural support for the header. Thus, the mold need not be made to withstand the operating pressures the header will encounter, which allows greater flexibility and precision in forming the header.

### BRIEF DESCRIPTION OF THE DRAWINGS

FIGS. 1A-1C illustrate a prior art filter.

FIGS. 2A-D illustrate a filter according to the present disclosure.

FIGS. 3A-C illustrate a geometrically variable underdrain header according to the present disclosure.

FIGS. 4A-C show a geometrically variable underdrain header according to the present disclosure.

FIGS. 5A-D show a geometrically variable underdrain header according to the present disclosure.

FIGS. 6A-D show a geometrically variable underdrain header whose cross section decreases continuously and non-linearly according to the present disclosure.

FIGS. 7A-D show a geometrically variable underdrain header whose cross section decreases continuously and non-linearly along the length of the header according to the present disclosure.

FIGS. 8A-C show a frusto-conical geometrically variable underdrain header according to the present disclosure.

FIGS. 9A-B illustrate a circular filter according to the present disclosure.

FIG. 10 illustrates a substantially continuous header with an initial boundary area.

FIGS. 11A-D show an embedded geometrically variable underdrain header with an exposed upper surface flush with the floor of the basin.

FIGS. 12A-12F show a basin form and a geometrically variable underdrain header mold according to aspects of the present disclosure.

FIGS. 13A-13E show the assembly of a basin form and a geometrically variable underdrain header mold according to aspects of the present disclosure.

FIGS. 14A-B show construction methods for a geometrically variable underdrain header mold.

FIGS. 15A-B show construction methods for a geometrically variable underdrain header mold.

FIGS. 16A-D show an internally reinforced geometrically variable underdrain header mold.

FIGS. 17A-D show a geometrically variable underdrain header mold externally reinforced with rebar.

FIGS. 18A-D show a construction method for steel sheets having channels.

FIGS. 19A-C illustrates a method of manufacturing a header mold with an air pipe assembly.

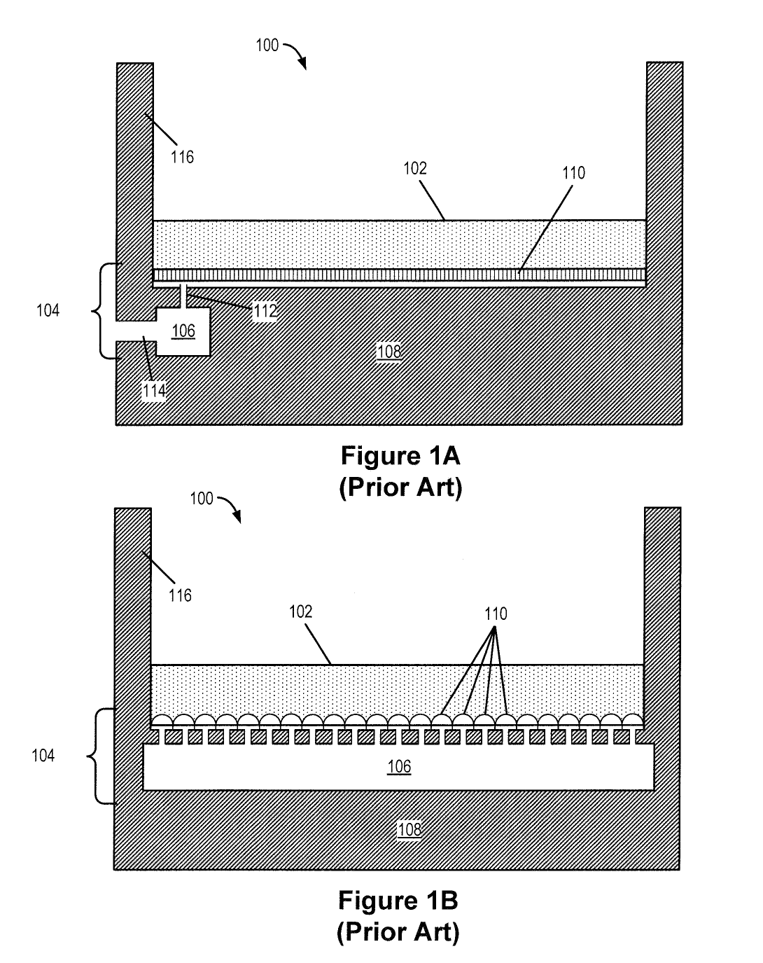

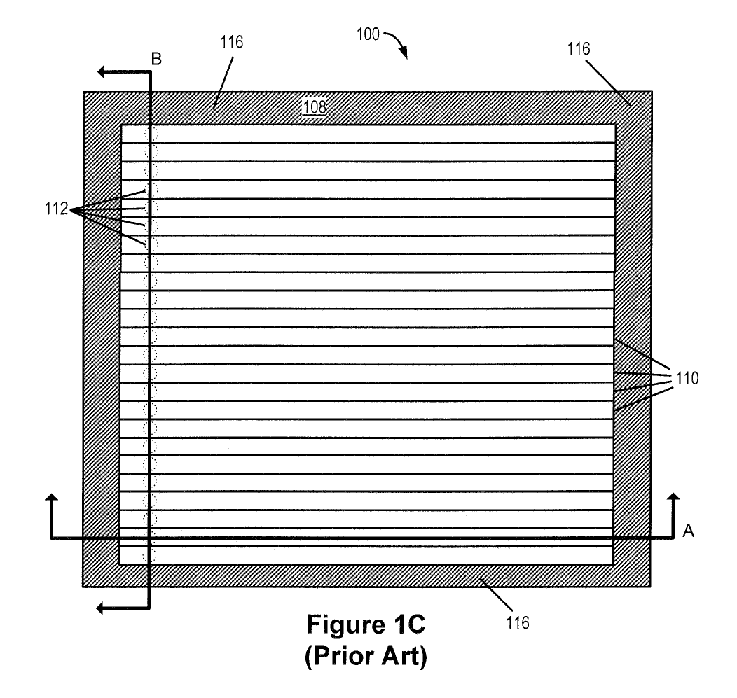

### DETAILED DESCRIPTION OF THE INVENTION

An exemplary filter having an embedded geometrically variable header will now be described with reference to the accompanying drawings. An embedded header is defined here as a header not protruding from the basin. Specific design details have been provided for illustration but should not be considered limiting. Readers of skill in the art will recognize that many variations of filter construction may be implemented consistent with the scope of the invention as described by the appended claims.

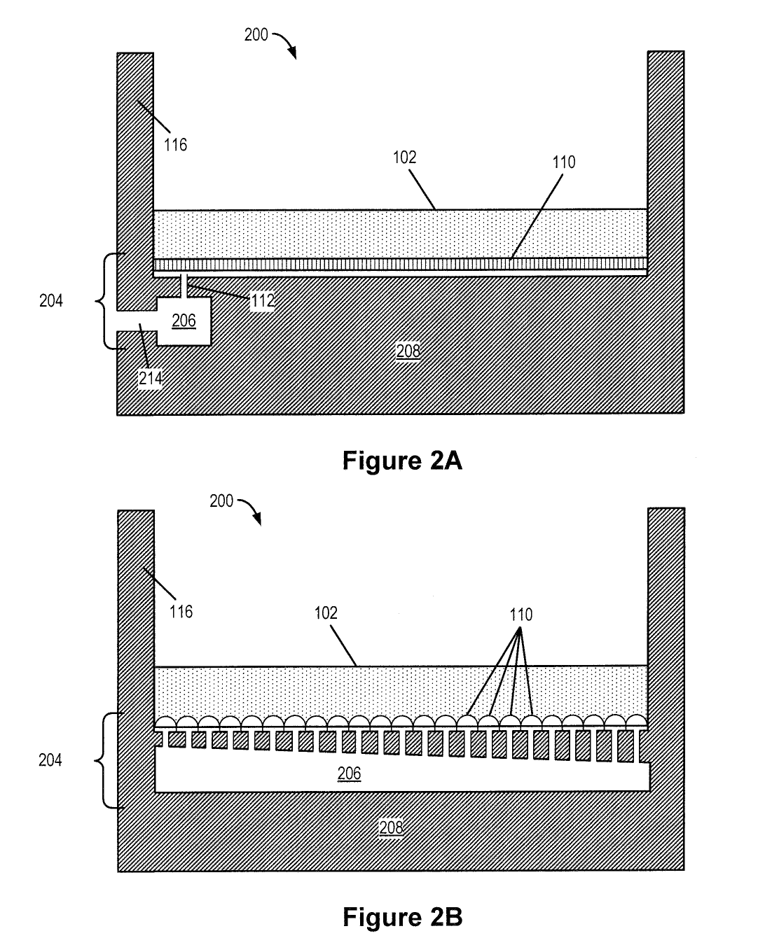

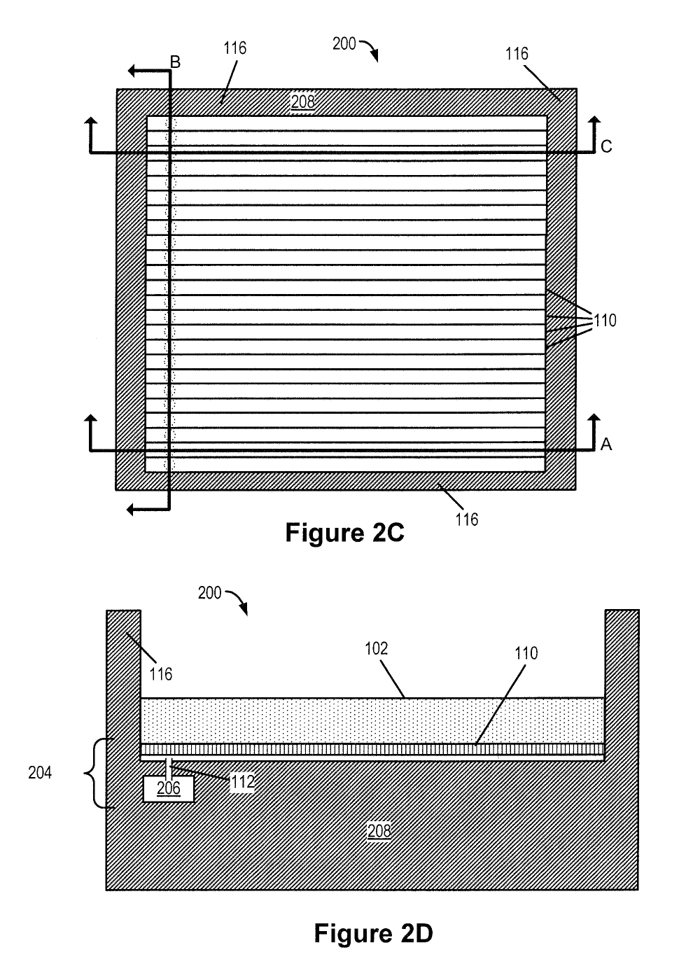

Turning now to FIGS. 2A-D, filter 200 includes a basin 208, a filtration medium 102 disposed within the basin 208, and an underdrain 204 including a geometrically variable underdrain header 206. The geometrically variable underdrain header 206 is completely encapsulated the floor of the basin 208. Filter 200 could also be constructed such that the header is completely encapsulated in a wall of basin 208.

FIG. 2C illustrates a plan view of the filter 200. FIG. 2A illustrates a view across one lateral at cross section A. FIG. 2B illustrates a view of filter 200 across all the laterals 110 at cross section B. FIG. 2D illustrates a view of filter 200 across all the laterals 110 at cross section C. Filter 200 includes laterals 110 with a passage 112 connecting each lateral 110 to the geometrically variable underdrain header 206. The laterals are preferably Triton™ laterals manufactured by Johnson Screens and described in U.S. Pat. No. 4,156,738 (“the '738 patent”), which is hereby incorporated by reference in its entirety. Laterals 110 and their installation are well-known prior art, thus such details are not repeated herein.

As shown in FIGS. 2A-D, the geometrically variable underdrain header 206 is an oblong passage configured so that the passage narrows along the length of the header 206, resulting in a continuously decreasing header cross section. Specifically, the header cross section at C (shown in FIG. 2D) is smaller than the cross section at A (shown in FIG. 2A). By continuously, we mean that the cross section's decrease is non-stepwise.

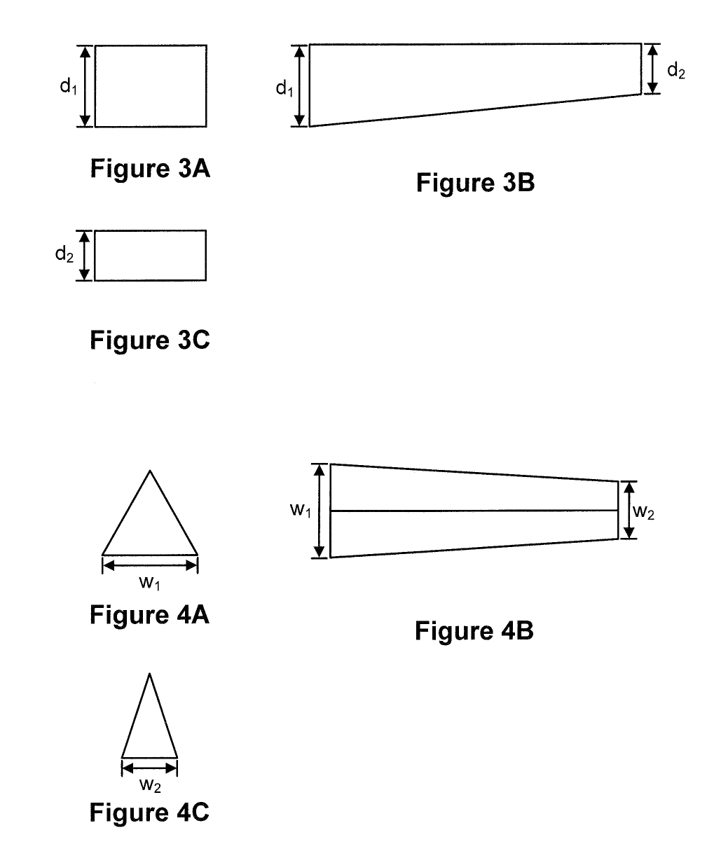

The cross section of the header 206 may be defined by multiple flat sides. The cross section of the illustrated header 206 is four-sided, although the header 206 may have any number of flat or curved sides. The cross section, or at least one dimension of the cross-section (e.g., height, width, radius, etc.) may decrease linearly or non-linearly. Various header designs are illustrated in FIGS. 3-8.

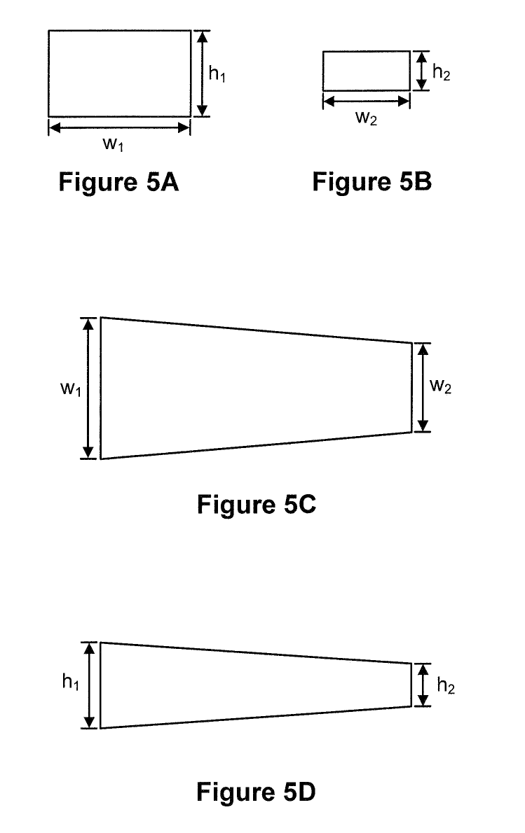

FIGS. 3A-C illustrate a header cross section continuously decreasing in depth (d) along the length of the header 206. FIGS. 3A and 3C illustrate the cross section of each end of the header 206, while FIG. 3B shows a side view. FIGS. 4A-C illustrate a triangular header cross section continuously and linearly decreasing in width (w) along the length of the header 206. FIGS. 4A and 4C illustrate the cross section of each end, while FIG. 4B shows a top view of the same header 206. FIGS. 5A-D each illustrate a header 206 having a rectangular cross section decreasing in height (h) and width (w) along the length of the header. FIG. 5A shows a sectional view of the wide end of the header 206. FIG. 5B shows a sectional view of the narrow end of the header 206. FIG. 5C shows a top view of the header 206. FIG. 5D shows a side view of the header 206.

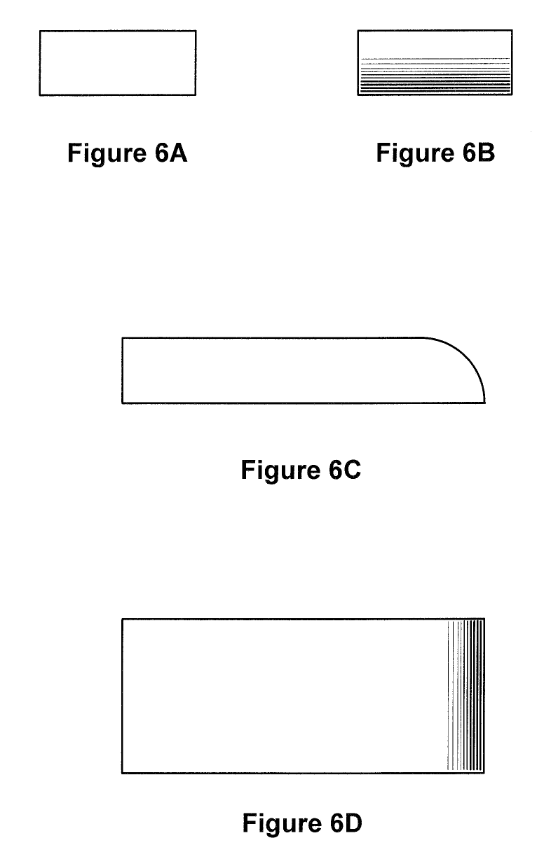

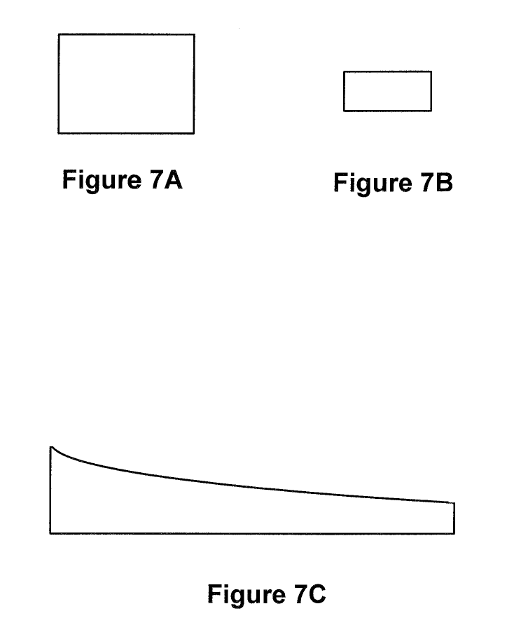

Although the embodiments illustrated above show header dimensions decreasing linearly along the header, the cross section of the header 206 may decrease non-linearly. FIGS. 6A-D show a header 206 where the cross section's rate of decrease along the length of the header increases. FIG. 6A shows the end view of the wide end of the geometrically variable underdrain header 206. FIG. 6B shows the end view of the narrow end of the geometrically variable underdrain header 206. FIG. 6C shows the side view of the geometrically variable underdrain header 206. FIG. 6D shows the top view of the geometrically variable underdrain header 206. Similarly, FIGS. 7A-C illustrate a header where the cross section's rate of decrease along the length of the header decreases. FIG. 7A shows the cross section of the wide end of the header 206. FIG. 7B shows the narrow end. FIG. 7C shows a side view of the geometrically variable underdrain header 206.

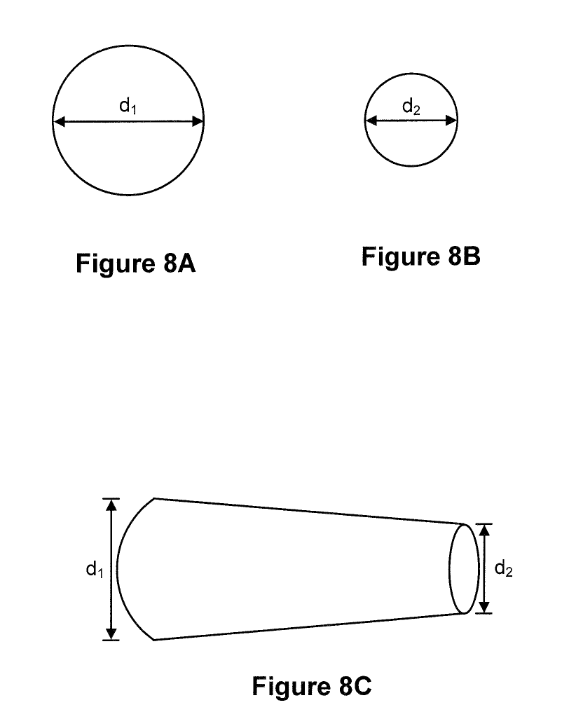

Rather than flat sides, the geometrically variable underdrain header 206 may be defined by a curved manifold that narrows along the length of the header 206. For example, the header could also be a frusto-conical shell with a circular cross section of decreasing diameter (d), as shown by FIGS. 8A-C. FIG. 8A shows a sectional view at the wide end of the geometrically variable underdrain header 206. FIG. 8B shows a sectional view at the narrow end of the geometrically variable underdrain header 206. FIG. 8C shows a perspective view of the geometrically variable underdrain header 206.

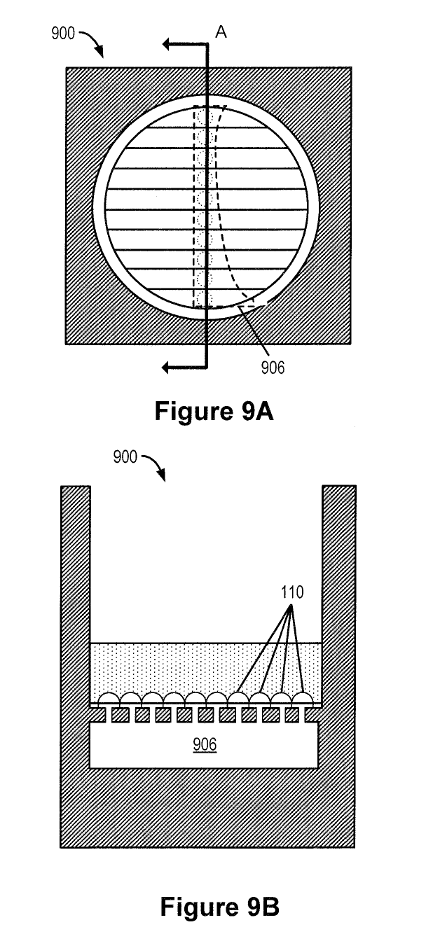

In contrast to the above header designs, in filters where the lateral length decreases along the length of the header, the header cross section may slightly increase after an initial decrease to equalize the pressure and flow increase caused by shorter laterals. FIGS. 9A and 9B illustrate a plan view and a view across all the laterals 110 at cross section A, respectively, of a circular filter 900 with a header 906 having a cross section that decreases and then slightly increases in a semi-parabolic curve.

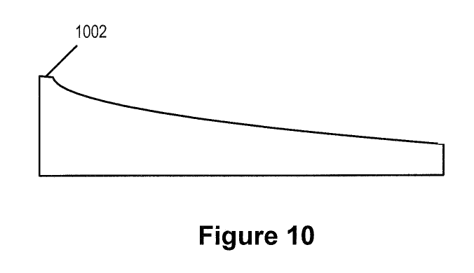

The headers 206 discussed above have continuously varying cross sections. These headers may be contrasted with a step-wise varying header, in which the changes in cross section are not continuous. It will be appreciated by those skilled in the art, however, that a header could be constructed with a short initial portion having one cross section and the remainder having a continuously decreasing cross section. Such headers will perform hydraulically very similarly to a truly continuously decreasing header, and thus should be considered substantially continuous. FIG. 10 therefore illustrates a substantially continuous header with an initial boundary area 1002.

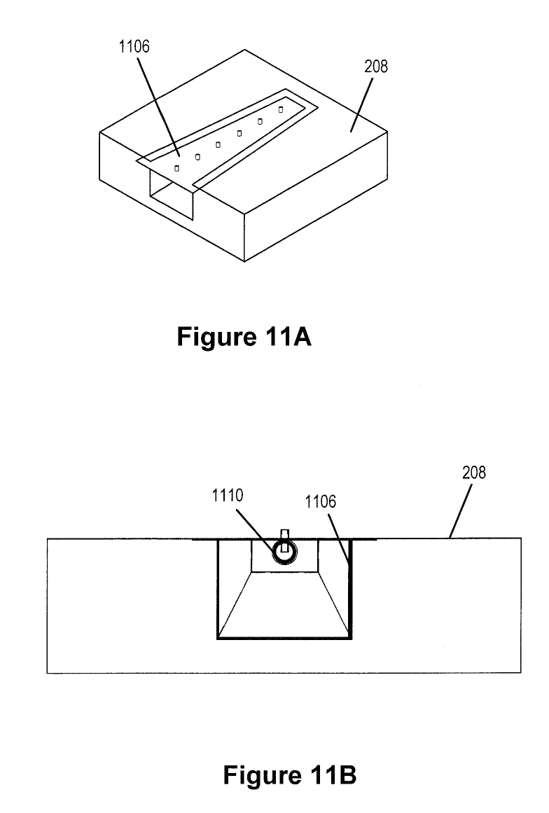

In contradistinction to the headers above, some headers may be embedded without being completely encapsulated. FIGS. 11A-D show an embedded geometrically variable underdrain header 1106 with an exposed upper surface 1108 flush with the floor 209 of the basin 208. FIG. 11A shows an elevated perspective view of the embedded underdrain header 1106 and basin 208. FIG. 11B shows a front perspective view of the embedded underdrain header 1106 and basin 208. FIG. 11C shows a top view of embedded underdrain header 1106 and basin 208. FIG. 11D shows a cross section of the embedded underdrain header 1106 and basin 208.

In addition to the passage (not shown) that connects the interior of the header 1106 with the lateral (not shown) for fluid delivery to and from the lateral, in some backwashing systems the header may introduce a gas such as air into the lateral separately during backwashing. For example, the underdrain header 1106 includes an air pipe assembly 1110 connected to an air source for supplying air to the lateral. The air pipe assembly 1110 includes an air distributor pipe 1112 attached to the interior of the underdrain header 1106 and multiple exit pipes 1114 running through the exposed upper surface 1108 in fluid communication with the interior 1116 of the air distributor pipe 1112 and the basin 208. The exit pipes 1114 each have slots 1118 in the portion of the exit pipe 1114 inside the air distributor pipe 1112. The slots 1118 connect the inside of an exit pipe with the exterior of the exit pipe for controlling an air plenum in the air distributor pipe 1112. The use of a slotted exit pipe to produce a plenum is well known in the art, and therefore is not discussed further. Although shown here in connection with a partially encapsulated underdrain header, an air pipe assembly 1110 may also be implemented with any of the fully encapsulated underdrain header designs discussed above.

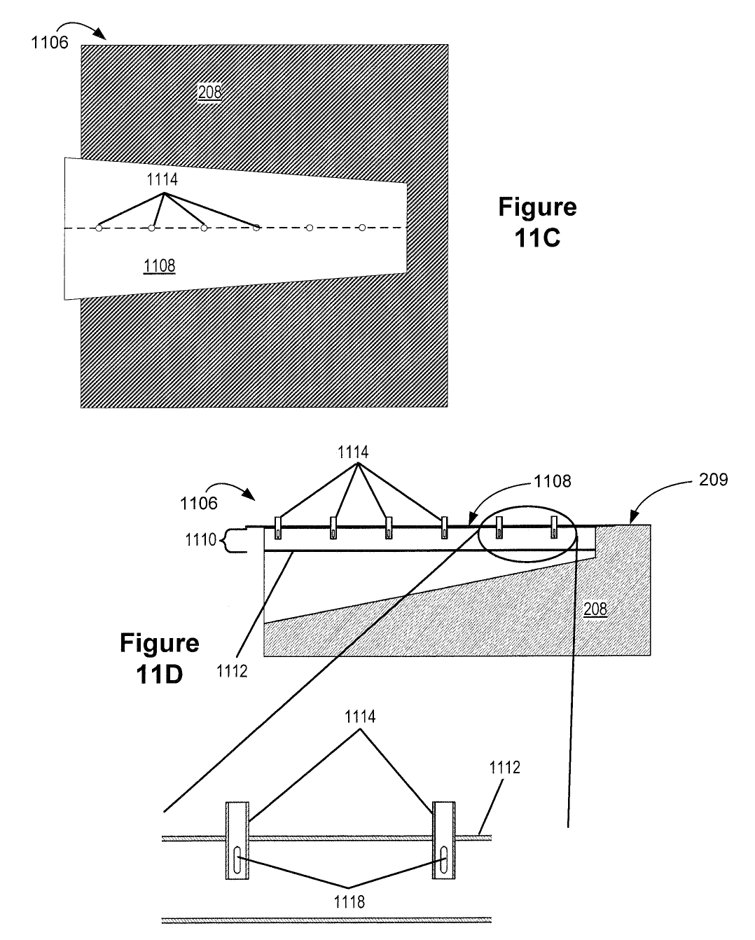

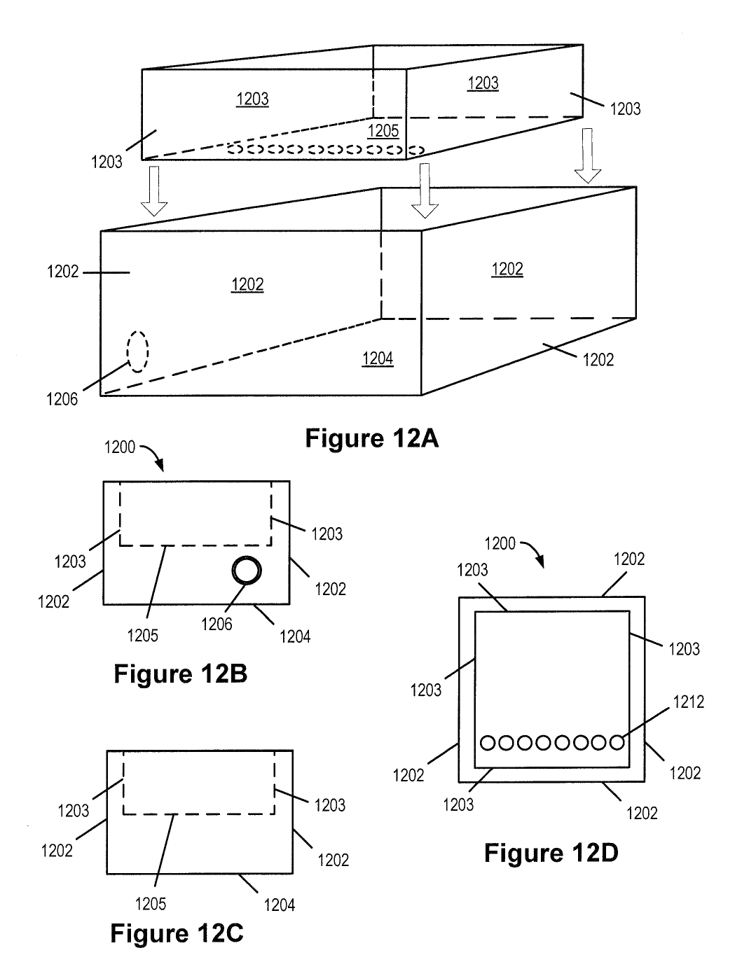

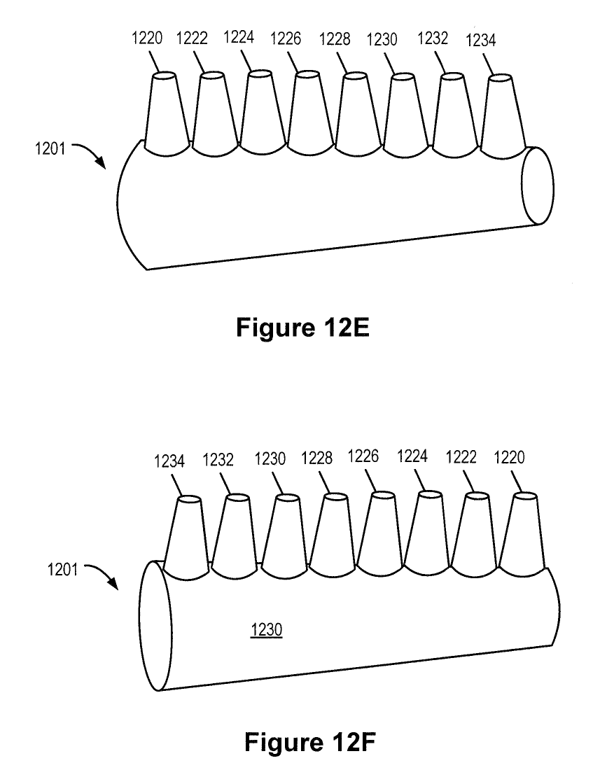

Construction of filters incorporating the header geometries discussed above will now be described, beginning with reference to FIG. 12A. Constructing a geometrically variable underdrain filter header 206 generally includes providing a basin form, disposing a geometrically variable underdrain header mold within the basin form, and pouring concrete in said basin form so as to encapsulate the header mold.

Providing a basin form may be carried out by various known prior art techniques, including assembling the basin form on-site or positioning a pre-fabricated basin form in a desired location. This may include placing an inner basin form component inside an outer basin form component, as shown in FIG. 12A. The basin form components may be made of wood, plastic, fiberglass, metal, or any other material that will occur to those of skill in the art.

FIGS. 12B-D illustrate an exemplary basin form 1200 after assembly. FIG. 12B shows a front view of basin form 1200. FIG. 12C shows a side view of basin form 1200. FIG. 12D shows a top view of basin form 1200. The outer basin form component 1200 has four outer sides 1202, and an outer floor 1204. The inner basin form component 1200 also includes four inner sides 1203 and an inner floor 1205 having openings 1212 for receiving the major passages of the header mold. The basin form 1200 also contains an opening 1206 for the header 206 to be coupled to a backwash media source 214. Alternatively, this can be done after the pour by connecting the backwash media source 214 to a flange on a header end protruding from the basin form 1200.

FIGS. 12E-F show an exemplary geometrically variable underdrain header mold. The header mold 1201 may be formed in any of the header configurations discussed above. The mold 1201 includes a main header body 1236, and passages 1220-1234 for distributing the backwash media to the laterals (not shown). The interior surface of the mold 1201 may also include supports or turbulence minimization devices. The mold 1201 may also include a mechanism for connecting to the backwash media source, such as a flange.

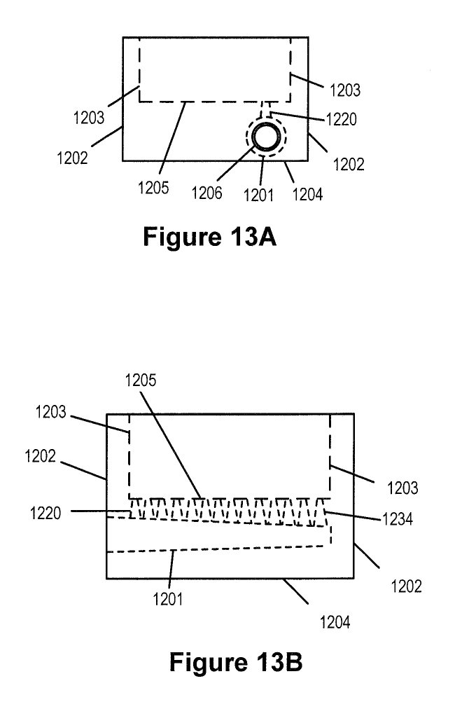

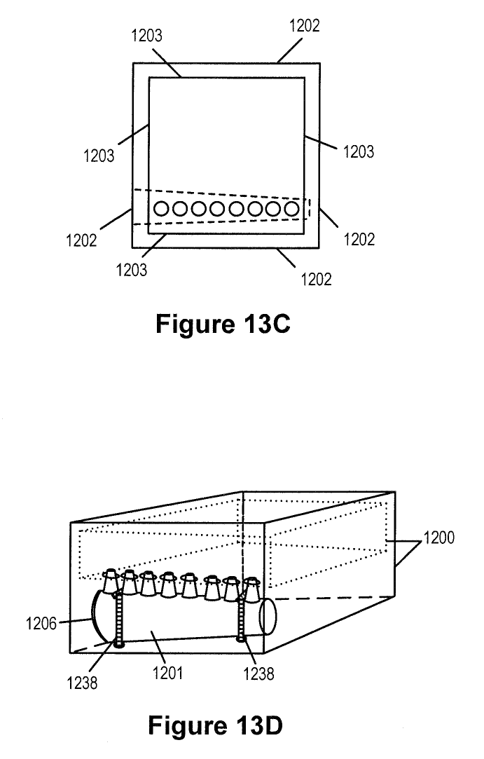

FIGS. 13A-C show header mold 1201 disposed within a basin form 1200. FIG. 13A shows a front view of header mold 1201 within basin form 1200. FIGS. 13B and 13C show a side view and top view, respectively. The mold 1201 is disposed within the basin form 1200 in a position corresponding with the header's final position. The main body 1236 and passages 1220-1234 are sealingly disposed in openings 1206 and 1212, respectively. The openings to main body 1236 and passages 1220-1234 are arranged so that no concrete enters the interior of mold 1201.

It may be necessary to anchor header mold 1401 in place prior to pouring concrete. An anchor 1238 may be attached to an appendage added to the mold 1201 for such a purpose or may be disposed about the mold 1201 itself, as shown in FIG. 13D. The anchor 1238 is also attached to the basin form 1200.

The header mold 1201 may be manufactured by many different processes and from many different materials. For example, the header mold 1201 may be made from sheet steel. Because the concrete around the header mold 1201 forms the actual header structure, the mold for the header may be made from relatively thin (e.g., 0.120-inch) polished steel sheets. This thinner steel is easier to cut, shape and weld than thicker steel. These polished steel sheets are readily available with a 2B finish, which provides a sufficient surface smoothness for the interior surface of the header 206. Using such sheets is more efficient and economical than traditional header manufacturing techniques, because no further treatment of the interior header surface is needed.

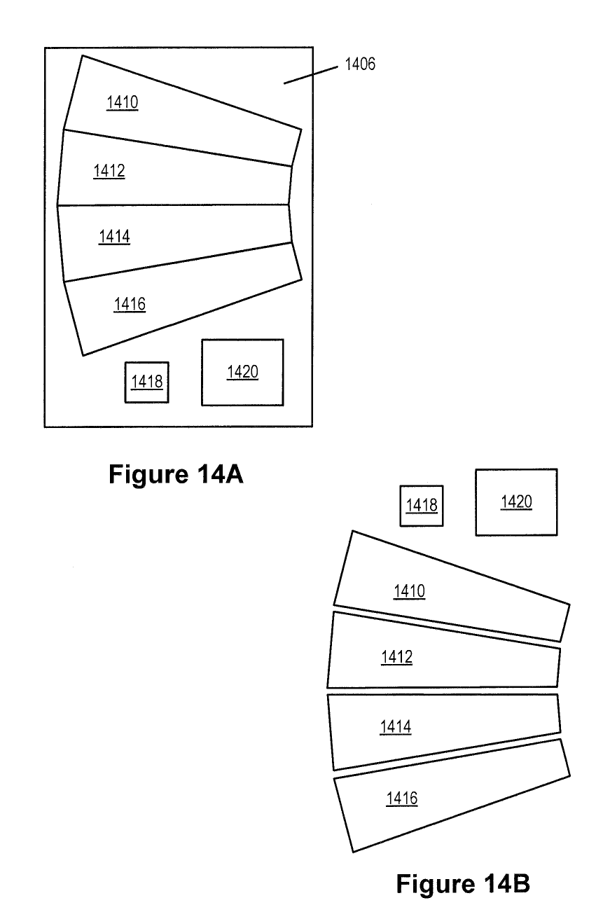

Header mold 1201 may be made by cutting sheet metal to sides of the desired dimensions and welding the sides together to form a continuous shell as illustrated in FIGS. 14A-B. FIGS. 14A-B show the sides 1410-1520 before (FIG. 14A) and after (FIG. 14B) they are cut from a steel sheet 1406. Because the welds need only hold until the concrete cures, the mold may be fabricated using surface (“fill-in”) welds or skip welds instead of full-penetration welds. These lighter welds may be completed more quickly and provide a higher margin of error.

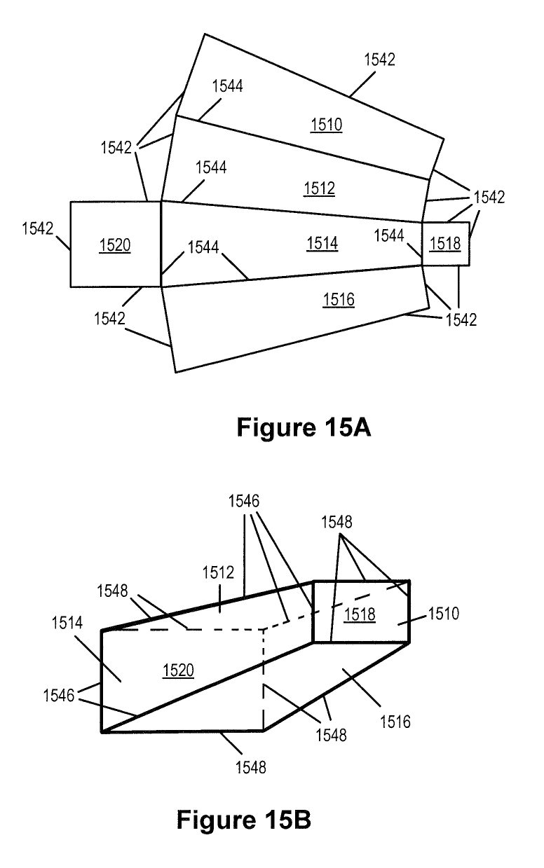

Header mold 1201 may also be manufactured by cutting a sheet of steel to a desired pattern, and then pressing (i.e., folding) the cut sheet into the desired header form. The pressed sheet may then be welded at the seams to create a continuous shell as illustrated in FIGS. 15A-15B.

FIGS. 15A-B show a cut steel sheet 1506 before (FIG. 15A) and after (FIG. 15B) it is folded along its edge lines 1544 and welded at its sheet edges 1542 to form a header mold 1201 with side panels 1510-1620. The folds at the sheet's 1506 edge lines 1544 become mold seams 1546, and welds at the sheet edges form mold seams 1548.

As described above with reference to FIGS. 12A-D, the geometrically variable underdrain header 206 may be frusto-conical instead of multi-sided. Such a header mold may be constructed from one or more pieces of steel sheet pressed into a curvilinear shape to comprise at least a portion of frusto-conical mold and welded at the seams to create a continuous shell. The header could also be a spun concrete shell which may optionally be lined with fiberglass, plastic, or a similar material.

Any of the header molds 1201 discussed above may be manufactured by extruding a plastic shell.

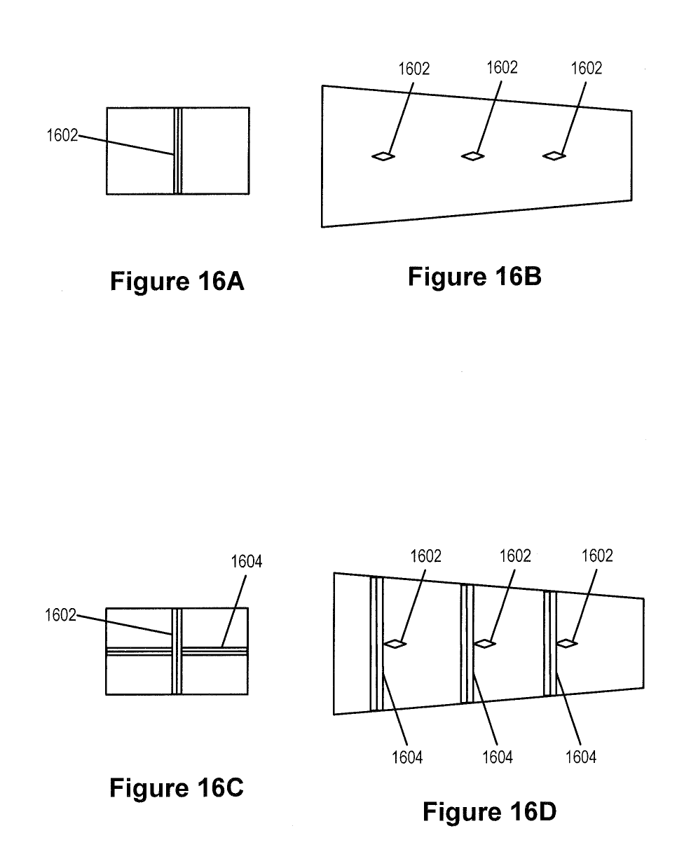

Header mold 1201 may require additional support to prevent the mold from collapsing under the weight of the cement during the pour and before the cement cures. Once the cement cures, it is generally self-supporting, although header 206 may require additional support even after the cement has cured. This support may be interior, exterior, or both. FIGS. 16A-D show a header mold 1201 with support members attached to the interior. FIGS. 16A and 16B show a header mold 1201 with vertical columns 1602 attached to the interior of the mold 1201, from an end view and a top view, respectively. The vertical columns 1602 may be welded in place or otherwise attached to the interior. As illustrated, the vertical columns 1602 are shaped as vanes for turbulence minimization. The metal column of FIGS. 16A and 16B is shaped and positioned as a vane for minimizing turbulence in liquids traveling through the header by preventing the side-to-side flow of liquid in the header.

FIG. 16C and FIG. 16D show a geometrically variable underdrain header mold 1201 with vertical columns 1602 and horizontal beams 1604 attached to the interior of the mold 1201, from an end view at the wide end of the mold and from a top sectional view, respectively. The horizontal beams 1604 in FIGS. 16C and 16D are also shaped as vanes for minimizing turbulence. The beams 1604 may be attached by any method used to attach the columns 1602.

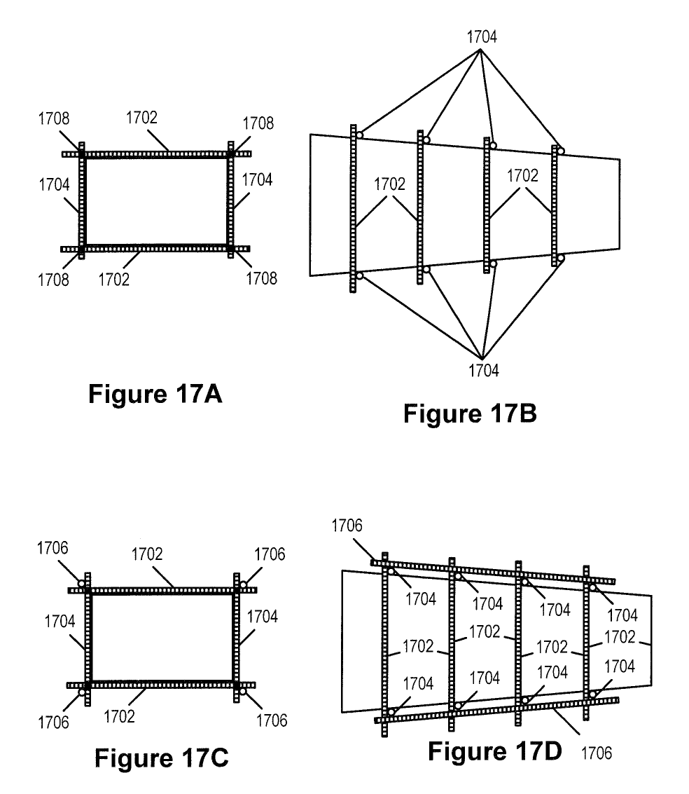

As an alternative to interior support, header mold 1201 may be externally reinforced. In one such arrangement, rebar is welded or otherwise attached to the outside of the mold. FIG. 17A shows an end view of a header mold 1201 cross-sectionally reinforced with rebar. FIG. 17B shows a top view of the same header mold 1201. The horizontal rebar 1702 and the vertical rebar 1704 are both welded to the outer surface of the mold 1201. The horizontal rebar 1702 and the vertical rebar 1704 are attached to each other at attachment points 1708. The rebar may be attached by welding, fasteners, or wound wire. Alternatively, a single section of rebar may be bent to conform to the shape of the mold 1201. FIGS. 17C and 17D show an end view and a top view, respectively, of cross-sectionally and longitudinally reinforced header mold 1201. Connection of the longitudinally reinforcing components may be the same as that of the cross sectional components.

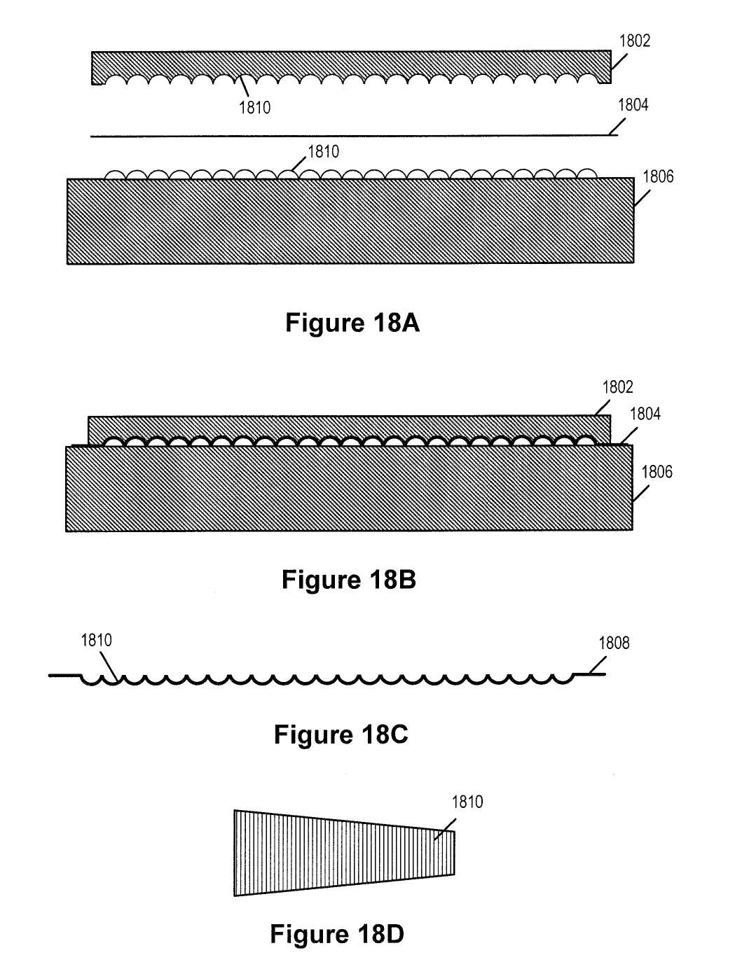

The exterior surface of header mold 1201 may also be manufactured with features that promote the flow of poured concrete around the mold and that prevent the retention of air in the concrete around the mold. Such features may take the form of channels in the header. FIGS. 18A-D illustrate a process of pressing channels into steel sheets during manufacturing of the geometrically variable underdrain header mold 901. FIG. 18A shows a press in an open position for pressing channels into a steel sheet. The steel sheet 1804 is placed between the upper press plate 1802 and the lower press plate 1806. The lower press plate 1806 has peaks 1812 and the upper press plate 1804 has valleys 1814, which are brought together in a pressing action to form corrugations 1810 into the steel sheet 1804.

FIG. 18B shows a press in a closed position, after pressing channels into a steel sheet. After pressing, the pressed steel sheet 1808 has channels 1810. The pressed steel sheet 1808 may then be used in constructing a geometrically variable underdrain header mold 1201 according to the method disclosed above. FIG. 18D below shows the side view of a geometrically variable underdrain header mold 1201 manufactured from one or more steel sheets 1804.

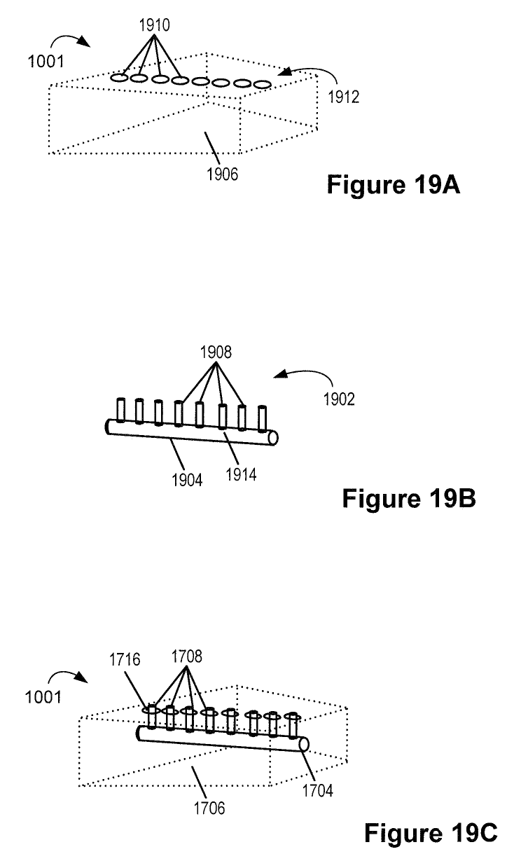

FIGS. 19A-C illustrate a method of manufacturing a geometrically variable header mold 1201 with an air pipe assembly 1902 as discussed above. FIG. 19A illustrates an exemplary header mold 1201 partially assembled. FIG. 19B shows an exemplary air pipe assembly 1902. FIG. 19C shows an exemplary air pipe assembly 1902 disposed within a header mold 1201. The interior of the header mold 1201 may be manufactured with an air pipe assembly 1902 by welding, gluing, or otherwise attaching an air distributor pipe 1904 to the interior 1906 of the header mold 1201. The header mold 1201 is positioned with multiple exit pipes 1908 disposed in ports 1910 in the top surface 1912 of the header mold 1201 so that the exit pipes 1908 are in fluid communication with the interior 1914 of the air distributor pipe 1904 and the area above the top surface 1912. The manufacture may further include sealing the annulus 1916 between each of the multiple exit pipes 1908 and the port 1910 in which it is disposed by welding, caulking, cementing and so on.

It should be understood that the inventive concepts disclosed herein are capable of many modifications. Such modifications may include modifications in the shape of the molds, the basin, and the header, the precise method of manufacture, and in particular the manner in which the cross-sectional area of the header decreases. To the extent such modifications fall within the scope of the appended claims and their equivalents, they are intended to be covered by this patent.

What is claimed is:

1. A filter comprising:
a basin;
a filtration medium disposed within the basin; and
an underdrain, including a geometrically variable underdrain header embedded in a wall or floor of the basin.

2. The filter of claim 1, wherein the geometrically variable underdrain header is completely encapsulated by a wall or floor of the basin.

3. The filter of claim 1, wherein the geometrically variable underdrain header comprises a passage having a substantially continuous decrease in cross sectional area along a length of the header.

4. The filter of claim 3, wherein the decrease in cross sectional area comes from a decrease in one header dimension.

5. The filter of claim 3, wherein the decrease in cross sectional area comes from a decrease in more than one header dimension.

6. The filter of claim 3, wherein the header comprises one or more flat sides.

7. The filter of claim 6, wherein the header cross section is substantially rectangular.

8. The filter of claim 3, wherein the header is defined by a curved manifold.

9. The filter of claim 8 wherein the header cross section is substantially circular.

10. The filter of claim 9, wherein the header is frusto-conical.

11. The filter of claim 1, wherein the geometrically variable underdrain header comprises a passage having a substantially continuous variation in cross sectional area along a length of the header, the variation comprising an initial decrease in cross sectional area along a length of the header followed by an increase in cross sectional area along a length of the header.

12. The filter of claim 1 wherein the header is defined by a mold permanently fixed into the basin.

13. The filter of claim 1, wherein the geometrically variable underdrain header further comprises an air delivery system attached to the underdrain header.

14. A method of constructing a filter, the filter including an underdrain with an underdrain header adapted for coupling to a backwash media source and for coupling to a plurality of laterals for distributing one or more backwash media from the backwash media source, the method comprising:
providing a basin form;
disposing a geometrically variable underdrain header mold within the basin form; and
pouring concrete in said basin form so as to embed said geometrically variable underdrain header mold.

15. The method of claim 14 wherein pouring concrete in said basin form so as to embed said geometrically variable underdrain header mold comprises completely encapsulating the underdrain header mold in concrete.

16. The method of claim 14 wherein providing a basin form comprises prefabricating the basin form.

17. The method of claim 14 wherein the basin form is made of wood.

18. The method of claim 14 wherein the basin form is made of fiberglass.

19. The method of claim 14 wherein disposing a geometrically variable underdrain header mold within the basin form comprises anchoring the mold within the basin form.

20. The method of claim 14 wherein disposing a geometrically variable underdrain header mold within the basin form comprises reinforcing the mold with rebar.

21. The method of claim 14, further comprising attaching an air delivery system to the underdrain header.

22. A header mold for creating an embedded filter underdrain header, the header mold adapted to be embedded in cement, wherein:
the header mold defines the header; and
the header mold has a substantially continuous decrease in cross sectional area along a length of the header.

23. The mold of claim 22 further comprising internal structural support members.

24. The mold of claim 22 further comprising channels for facilitating the flow of concrete around the mold.

25. The mold of claim 22 further comprising channels for facilitating the escape of air from concrete around the mold.

26. The mold of claim 22 further comprising an anchoring means for anchoring the mold.

27. The mold of claim 22, further comprising an air delivery system.

28. A method of making a header mold for use in creating an embedded filter underdrain header in a basin, comprising forming the mold with a substantially continuous decrease in cross sectional area from a first end of the geometrically variable underdrain header mold to a second end of the geometrically variable underdrain header mold.

29. The method of claim 28 further comprising reinforcing the mold with rebar.

30. The method of claim 28 comprising:
cutting sheet metal to form sides of the geometrically variable underdrain header mold; and
welding the sides together to form the geometrically variable underdrain header mold.

31. The method of claim 28 comprising:
cutting a sheet of steel to a desired pattern;
pressing the cut sheet into the desired header form; and
welding the pressed sheet at the seams to create a continuous shell.

32. The method of claim 28 comprising forming the underdrain header mold from extruded plastic.

33. The method of claim 28 comprising forming the underdrain header mold from spun concrete.

34. The method of claim 28 further comprising pressing channels in the sheet metal to facilitate concrete flow during the step of pouring concrete in said basin form around said mold.

35. The method of claim 28, further comprising attaching an air delivery system to the underdrain header mold.
